(19) United States
(12) Patent Application Publication
(10) Pub. No.: US 2012/0134176 A1
(43) Pub. Date: May 31, 2012

(54) BACKLIGHT MODULE AND LIGHT GUIDE PLATE THEREOF

(75) Inventors: Kuangyao Chang, Shenzhen (CN); Kuojun Fang, Shenzhen (CN)

(73) Assignee: SHENZHEN CHINA STAR OPTOELECTRONICS TECHNOLOGY CO., LTD., Shenzhen (CN)

(21) Appl. No.: 13/217,642

(22) Filed: Aug. 25, 2011

(30) Foreign Application Priority Data
Nov. 30, 2010 (CN) 201010571393.3

(51) Int. Cl. F21V 8/00

(52) U.S. Cl. 362/606; 362/615

(57) ABSTRACT

The present invention discloses a backlight module and a light guide plate thereof. The light guide plate has a side incident surface, a light-emitting surface adjacent to the side incident surface, and a micro-structure array adjacent to the side incident surface. The side incident surface receives incident lights from a light source. The micro-structure array has a plurality of elongated prisms, and an end of each of the prisms is oriented to the side incident surface, so that an extension direction of each prism is parallel to or nearly parallel to a normal line of a light-emitting surface of the light source. The light guide plate can increase light transmission distance to provide uniform brightness. The structures of the prisms are maintained in a uniform arrangement, so that a prism mold need not be re-designed to satisfy requirements of panels with different sizes.

### FIELD OF THE INVENTION

The present invention relates to a backlight module and a light guide plate thereof, and more particularly to a backlight module and a light guide plate thereof that the structure and the directional arrangement of prisms of the light guide plate can enhance brightness of the backlight module, increase light transmission distance and provide uniform brightness.

### BACKGROUND OF THE INVENTION

Since a liquid crystal panel of a liquid crystal display device does not has a self-luminous function, therefore the liquid crystal display device further needs a backlight module to provide the liquid crystal panel a sufficient and uniform surface light source. Generally speaking, backlight modules are mainly divided into two types of direct type and edge type, wherein a light guide plate is a key component for an edge type backlight module to provide a uniform surface light source. The light guide plate uses the principle of total reflection to transmit lights entered from a side of the light guide plate to a far end of the light guide plate, and dot patterns in a bottom of the light guide plate are to reflect and diffuse the lights with various angles, so as to guide the lights to a front surface (i.e. light-emitting surface) of the light guide plate. The light-emitting surface of the light guide plate may further have a micro-structure array mounted thereon to increase overall illumination uniformity and brightness.

With reference to FIG. 1, FIG. 1 discloses a perspective view of a conventional prism-structural light guide plate. The light guide plate has a side incident surface 90 and a light-emitting surface 91. The side incident surface 90 is at a side of the light guide plate for facing a light source 94 to receive incident lights from the light source 94. The light source 94 may be constructed by a plurality of light-emitting assemblies 940. The light-emitting surface 91 has a micro-structure array 92 mounted thereon. The micro-structure array 92 is constructed by a plurality of elongated prisms 920 arranged side by side, and each of the prisms 920 is extended toward an extension direction, wherein the extension direction is perpendicular to a normal line of a light-emitting surface of the light source 94. When lights enter the light guide plate from the side incident surface 90, the lights transmit inside the light guide plate by total internal reflection. The micro-structure array 92 will frustrate the total internal reflection for the incident lights, so as to transmit the lights out from the light-emitting surface 91.

Although the micro-structure array 92 has a function on concentrating lights to enhance brightness of the light guide plate, the prism-structure of the micro-structure array 92 has a periodical change to light transmission direction, which causes light transmission distance to be decreased. Therefore, when applying the light guide plate to large size backlight modules, in order to maintain uniform brightness of the light guide plate, several means of adjusting the structure design of the micro-structure array 92 are used: (1) adjusting density of arrangement of the prisms 920 (as shown in FIG. 2), in other words, adjusting the pitches P between the prisms 920; (2) adjusting height H of each of the prisms 920 (as shown in FIG. 3); (3) adjusting geometry of each of the prisms 920, for example, forming rounded portions with different sizes on tops of the prisms 920, respectively. However, the aforementioned means all need to re-design molds, which will extend the time on product testing and certification, and lead to an increase of manufacture cost and difficulty.

Hence, it is necessary to provide a backlight module and a light guide plate thereof to overcome the problems existing in the conventional technology.

### SUMMARY OF THE INVENTION

A primary object of the invention is to provide a light guide plate, wherein the prism structures thereof are maintained in a uniform arrangement for increasing light transmission distance to provide uniform brightness, so that a prism mold need not be re-designed to satisfy requirements of panels with different sizes.

A secondary object of the present invention is to provide a backlight module which prism structures of a light guide plate thereof are maintained in a uniform arrangement, and with a light-emitting surface of a light source cooperating with an extension direction of the prism structures, light transmission distance can be increased to provide uniform brightness, so that a prism mold need not be re-designed to satisfy requirements of panels with different sizes and simultaneously reduce use of optical films.

To achieve the above object, the present invention provides a light guide plate, and the light guide plate comprises:

a side incident surface receiving incident lights from a light source;

a light-emitting surface adjacent to the side incident surface; and

a micro-structure array adjacent to the side incident surface and having a plurality of elongated prisms arranged side by side, wherein the prisms are parallel to each other, and each of the prisms is extended toward an extension direction, and an end of each of the prisms is oriented to the side incident surface.

In one embodiment of the present invention, the micro-structure array is formed on the light-emitting surface of the light guide plate.

In one embodiment of the present invention, the micro-structure array is formed on a back surface of the light guide plate, and the back surface is a planar surface adjacent to the side incident surface and opposite to the light-emitting surface of the light guide plate.

In one embodiment of the present invention, the light source is disposed at a side of the light guide plate, and a light-emitting surface of the light source faces the side incident surface of the light guide plate, and the extension direction of each of the prisms is parallel to a normal line of the light-emitting surface of the light source.

In one embodiment of the present invention, the light source is disposed at a side of the light guide plate, and a light-emitting surface of the light source faces the side incident surface of the light guide plate, and an angle of θ is included between the extension direction of each of the prisms and a normal line of the light-emitting surface of the light source, wherein −π/30≦θ≦π/30.

In one embodiment of the present invention, the light source includes a plurality of light-emitting diode assemblies arranged side by side.

In one embodiment of the present invention, the light source includes at least one cold cathode fluorescent lamp.

The present invention further provides a backlight module, and the backlight module comprises:

a back board;

a light guide plate mounted on the back board, wherein the light guide plate has a side incident surface, a light-emitting surface and a micro-structure array, wherein the light-emitting surface is adjacent to the side incident surface, and the micro-structure is adjacent to the side incident surface and has a plurality of elongated prisms arranged side by side, and the prisms are parallel to each other or nearly parallel to each other, and each of the prisms is extended toward an extension direction, wherein an end of each of the prisms is oriented to the side incident surface; and

a light source mounted on the back board and disposed at a side of the light guide plate, wherein a light-emitting surface of the light source faces the side incident surface of the light guide plate.

In one embodiment of the present invention, the micro-structure array is formed on the light-emitting surface of the light guide plate.

In one embodiment of the present invention, the micro-structure array is formed on a back surface of the light guide plate, and the back surface is a planar surface adjacent to the side incident surface and opposite to the light-emitting surface of the light guide plate.

In one embodiment of the present invention, the extension direction of each of the prisms is parallel to a normal line of the light-emitting surface of the light source.

In one embodiment of the present invention, an angle of θ is included between the extension direction of each of the prisms and a normal line of the light-emitting surface of the light source, wherein −π/30≦θ≦π/30.

In one embodiment of the present invention, the light source includes a plurality of light-emitting diode assemblies arranged side by side.

In one embodiment of the present invention, the light source includes at least one cold cathode fluorescent lamp.

### DESCRIPTION OF THE DRAWINGS

FIG. 1 is a perspective view of a light guide plate with a light source according to a prior art;

FIG. 2 is a side view of another light guide plate with a light source according to another prior art;

FIG. 3 is a side view of still another light guide plate with a light source according to further another prior art;

FIG. 4 is a perspective view of a light guide plate of a first embodiment in accordance with the present invention;

FIG. 5 is a side view of the light guide plate in FIG. 4;

FIG. 6 is a top view of the light guide plate of a second embodiment in accordance with the present invention;

FIG. 6A is a partially enlarged view of the light guide plate in FIG. 6;

FIG. 7 is a perspective view of the light guide plate in FIG. 6; and

FIG. 8 is a perspective view of the light guide plate of a third embodiment in accordance with the present invention.

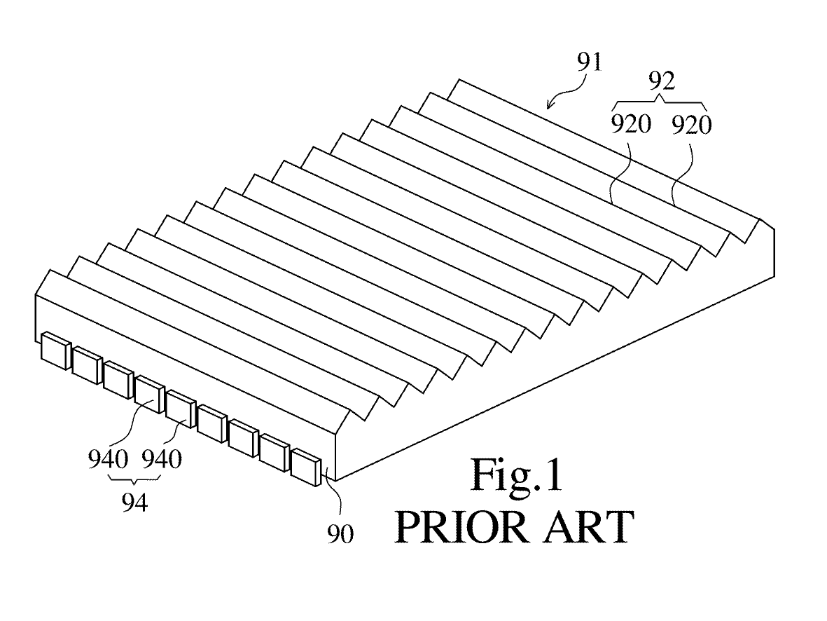

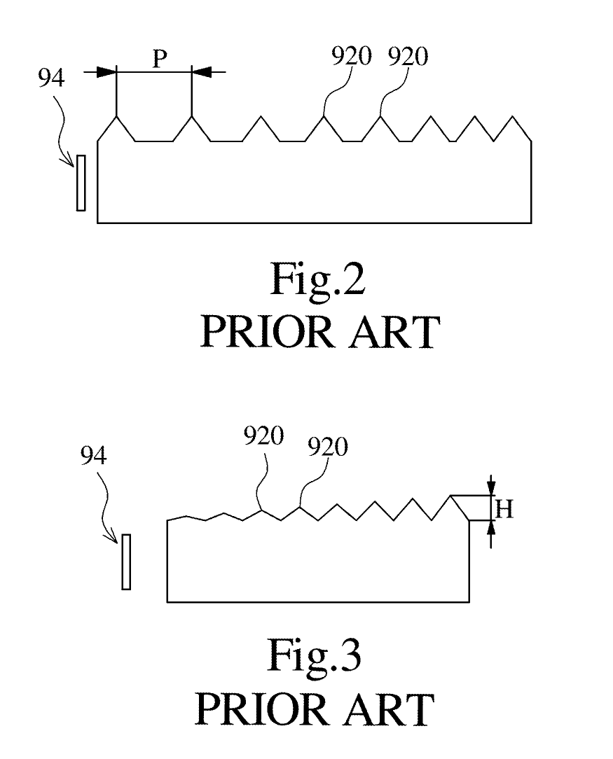

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

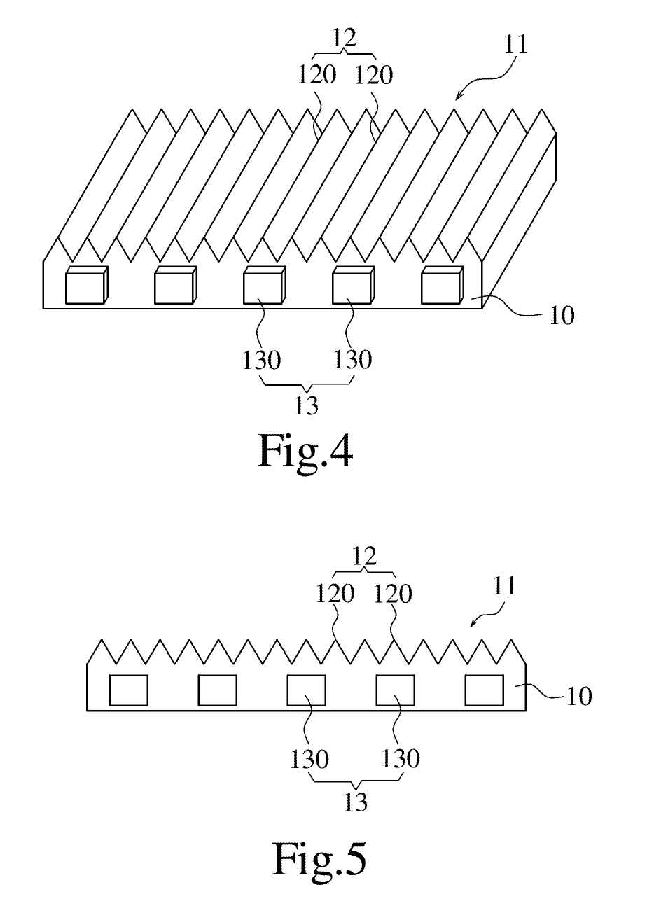

With reference to FIGS. 4 and 5, FIG. 4 is a perspective view of a light guide plate of a first embodiment in accordance with the present invention, and FIG. 5 is a side view of the light guide plate in FIG. 4. The light guide plate comprises a side incident surface 10, a light-emitting surface 11 and a micro-structure array 12. The light guide plate is used with a light source 13. The light guide plate and the light source 13 are used to be mounted in an edge-type backlight module, wherein the light guide plate is preferably mounted on a back board of the backlight module. The light guide plate is preferably made of polymethyl methacrylate (PMMA), methyl methacrylate-styrene copolymer (MS), polycarbonate (PC), Polystyrene (PS) or mixtures thereof, but is not limited thereto.

The side incident surface 10 is a sidewall of the light guide plate that is to receive incident lights emitted by the light source 13. The light source 13 is mounted on the back board and disposed at a side of the light guide plate, and a light-emitting surface of the light source 13 faces the side incident surface 10 of the light guide plate. The light source 13 preferably includes a plurality of light-emitting diode assemblies 130 arranged side by side or at least one cold cathode fluorescent lamp, but is not limited thereto.

The light-emitting surface 11 of the light guide plate is adjacent to the side incident surface 10.

The micro-structure array 12 is adjacent to the side incident surface 10. In this embodiment, the micro-structure array 12 is formed on the light-emitting surface 11 of the light guide plate and has a plurality of elongated prisms 120. Each of the prisms 120 is extended toward an extension direction, wherein an end of each of the prism 120 is oriented to the side incident surface 10. In the present embodiment, the extension direction of each of the prisms 120 is parallel to a normal line of the light-emitting surface of the light source 13. Furthermore, the prisms 120 arranged side by side may be parallel to each other or nearly parallel to each other. If being nearly parallel to each other, an angle between ridgelines of every two adjacent prisms 120 is preferably smaller than π/30.

Since the extension direction of each prism 120 is parallel to the normal line of the light-emitting surface of the light source 13, with the total internal reflection caused by the structure of the prisms 120, transmission distance of light emitted into the light guide plate will be effectively increased, so that the light guide plate can electively provide uniform brightness without changing overall structure of the micro-structure array 12 and also reduce the use of optical films. Therefore, the light guide plate of the present invention is adapted to large size panels. Meanwhile, because the prisms 120 are structurally maintained in a uniform arrangement, the light guide plate will need not be changed on mold design in a rolling press manufacturing process to satisfy requirements of panels with different sizes, and thereby design cost of mold can be reduced.

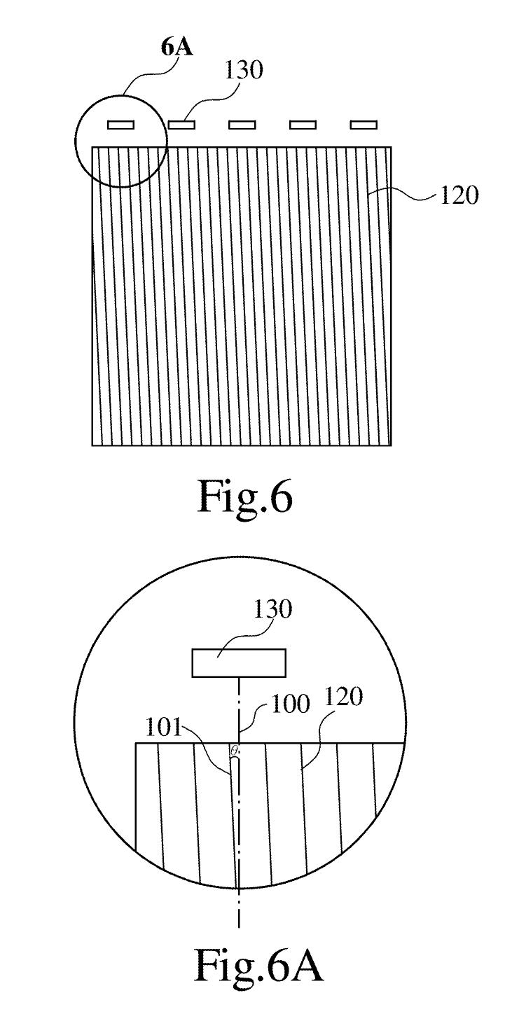

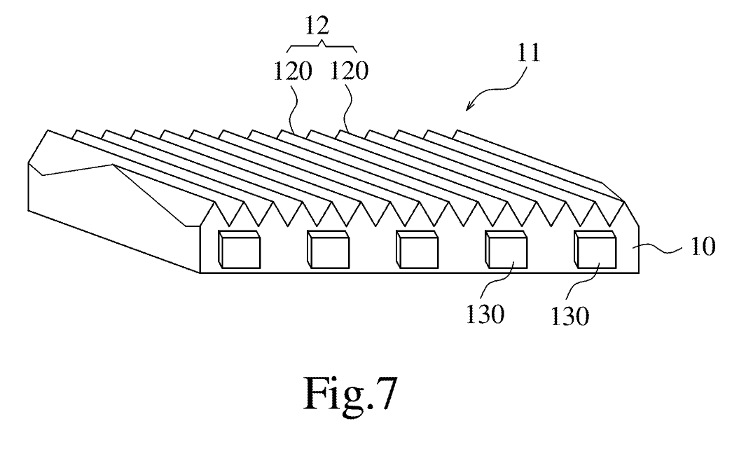

With further reference to FIGS. 6, 6A and 7, FIG. 6 is a top view of the light guide plate of a second embodiment in accordance with the present invention; FIG. 6A is a partially enlarged view of the light guide plate in FIG. 6; and FIG. 7 is a perspective view of the light guide plate in FIG. 6. The light guide plate of the second embodiment of the present invention is similar to the light guide plate of the first embodiment of the present invention, so as to use similar terms and numerals of the first embodiment, but the difference of the second embodiment is characterized in that: with reference to FIG. 6A, an angle of θ is included between an extension direction 101 of each of the prisms 120 and a normal line 100 of the light-emitting surface of the light source 13, wherein −π/30≦θ≦π/30. In this range of angle, the structure of the prisms 120 can increase light transmission distance as well to provide uniform brightness.

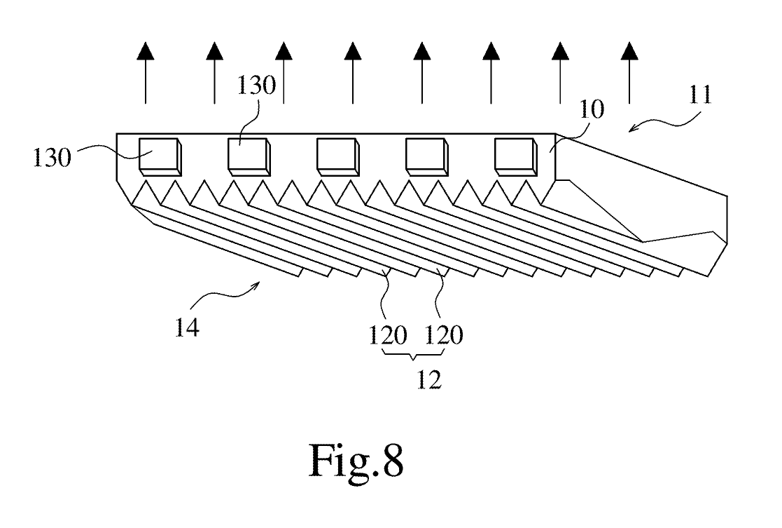

With further reference to FIG. 8, FIG. 8 is a perspective view of the light guide plate of a third embodiment in accordance with the present invention. The light guide plate of the third embodiment of the present invention is similar to the light guide plate of the first embodiment of the present invention, so as to use similar terms and numerals of the first embodiment, but the difference of the third embodiment is characterized in that: the micro-structure array 12 is formed on a back surface 14 of the light guide plate, and the back surface 14 is a planar surface and adjacent to the side incident surface 10 and opposite to the light-emitting surface 11. The prisms 120 of micro-structure array 12 in the opposite of the light-emitting surface 11 still can frustrate the total internal reflection to achieve an object of light emission from the light-emitting surface 11.

In conclusion, comparing with conventional prism-structural light guide plate that extension direction of each prism thereof is perpendicular to a normal line of a light-emitting surface of a light source, although such structure has a function on concentrating lights to enhance the brightness performed by the light guide plate, but when being applied to large size panel, it is necessary to adjust the structures of the prisms for the light guide plate to maintain uniform brightness. The present invention arranges the extension direction of each of the prisms of the light guide plate to be nearly parallel to the normal line of the light-emitting surface of the light source, such that when maintaining a uniform arrangement of the structures of the prisms, the light guide plate can still provide uniform brightness, and thereby reduce related cost of mold and the use of optical films.

The present invention has been described with a preferred embodiment thereof and it is understood that many changes and modifications to the described embodiment can be carried out without departing from the scope and the spirit of the invention that is intended to be limited only by the appended claims.

1. A light guide plate, characterized in that: the light guide plate comprises:
a side incident surface receiving incident lights from a light source, wherein the light source is disposed at a side of the light guide plate, and a light-emitting surface of the light source faces the side incident surface of the light guide plate;
a light-emitting surface adjacent to the side incident surface; and
a micro-structure array formed on the light-emitting surface of the light guide plate, adjacent to the side incident surface and having a plurality of elongated prisms arranged side by side, wherein the prisms are parallel to each other or nearly parallel to each other, and each of the prisms is extended toward an extension direction, wherein an end of each of the prisms is oriented to the side incident surface, and an angle of θ is included between the extension direction of each of the prisms and a normal line of the light-emitting surface of the light source, wherein −π/30≦θ≦π/30.

2. A light guide plate, characterized in that: the light guide plate comprises:
a side incident surface receiving incident lights from a light source;
a light-emitting surface adjacent to the side incident surface; and
a micro-structure array adjacent to the side incident surface and having a plurality of elongated prisms arranged side by side, wherein the prisms are parallel to each other or nearly parallel to each other, and each of the prisms is extended toward an extension direction, and an end of each of the prisms is oriented to the side incident surface.

3. The light guide plate as claimed in claim 2, characterized in that: the micro-structure array is formed on the light-emitting surface of the light guide plate.

4. The light guide plate as claimed in claim 2, characterized in that: the micro-structure array is formed on a back surface of the light guide plate, and the back surface is a planar surface adjacent to the side incident surface and opposite to the light-emitting surface of the light guide plate.

5. The light guide plate as claimed in claim 2, characterized in that: the light source is disposed at a side of the light guide plate, and a light-emitting surface of the light source faces the side incident surface of the light guide plate, and the extension direction of each of the prisms is parallel to a normal line of the light-emitting surface of the light source.

6. The light guide plate as claimed in claim 2, characterized in that: the light source is disposed at a side of the light guide plate, and a light-emitting surface of the light source faces the side incident surface of the light guide plate, and an angle of θ is included between the extension direction of each of the prisms and a normal line of the light-emitting surface of the light source, wherein −π/30≦θ≦π/30.

7. A backlight module, characterized in that: the backlight module comprises:
a back board;
a light guide plate mounted on the back board, wherein the light guide plate has a side incident surface, a light-emitting surface and a micro-structure array, wherein the light-emitting surface is adjacent to the side incident surface, and the micro-structure is adjacent to the side incident surface and has a plurality of elongated prisms arranged side by side, and the prisms are parallel to each other or nearly parallel to each other, and each of the prisms is extended toward an extension direction, wherein an end of each of the prisms is oriented to the side incident surface; and
a light source mounted on the back board and disposed at a side of the light guide plate, wherein a light-emitting surface of the light source faces the side incident surface of the light guide plate.

8. The backlight module as claimed in claim 7, characterized in that: the micro-structure array is formed on the light-emitting surface of the light guide plate.

9. The backlight module as claimed in claim 7, characterized in that: the micro-structure array is formed on a back surface of the light guide plate, and the back surface is a planar surface adjacent to the side incident surface and opposite to the light-emitting surface of the light guide plate.

10. The backlight module as claimed in claim 7, characterized in that: the extension direction of each of the prisms is parallel to a normal line of the light-emitting surface of the light source.

11. The backlight module as claimed in claim 8, characterized in that: the extension direction of each of the prisms is parallel to a normal line of the light-emitting surface of the light source.

12. The backlight module as claimed in claim 9, characterized in that: the extension direction of each of the prisms is parallel to a normal line of the light-emitting surface of the light source.

13. The backlight module as claimed in claim 7, characterized in that: an angle of θ is included between the extension direction of each of the prisms and a normal line of the light-emitting surface of the light source, wherein −π/30≦θ≦π/30.

14. The backlight module as claimed in claim 8, characterized in that: an angle of θ is included between the extension direction of each of the prisms and a normal line of the light-emitting surface of the light source, wherein −π/30≦θ≦π/30.

15. The backlight module as claimed in claim 9, characterized in that: an angle of θ is included between the extension direction of each of the prisms and a normal line of the light-emitting surface of the light source, wherein −π/30≦θ≦π/30.
